(19) United States
(12) Patent Application Publication
(10) Pub. No.: US 2025/0361104 A1
(43) Pub. Date: Nov. 27, 2025

(54) APPARATUS FOR DE-STACKING AND SORTING BOOK BLOCKS

(71) Applicant: Müller Martini Holding AG, Hergiswil (CH)

(72) Inventor: Mike THALMANN, Sursee (CH)

(21) Appl. No.: 19/204,664

(22) Filed: May 12, 2025

(30) Foreign Application Priority Data
May 27, 2024 (DE) 10 2024 114 834.9

(51) Int. Cl. B65H 3/12

(52) U.S. Cl. CPC B65H 3/122; B65H 2301/42322

(57) ABSTRACT

An apparatus separates printed products that have been assembled into a stack. The apparatus includes a conveyor for transporting the stack, which is connected to an advanceable element, which implements separation of the printed products in the stack. The printed products in a receiving support are transferred into a skewed position, which leads to a reduction of the load on the printed products that are to be de-stacked. A retainer, which is part of the receiving support, and a support are set with a clearance with respect to the predefined printed product thickness.

### CROSS REFERENCE TO RELATED APPLICATIONS

This application claims benefit to German Patent Application No. DE 10 2024 114 834.9, filed on May 27, 2024, which is hereby incorporated by reference herein.

### FIELD

The present disclosure is directed to an apparatus for de-stacking and sorting book blocks.

### BACKGROUND

In the present-day production of books, books with different finishes are increasingly being ordered to direct demand, and therefore the production facilities and machines must have a high degree of digitization to be able to implement this provision under economic conditions, i.e. the facilities and machines must be capable of directly and economically implementing digitized orders for small and very small print runs and a “book-of-one”, which require that the facilities and machines are operated such that they are capable, fully automatically, i.e. without manual intervention, of directly implementing the flow of incoming production instructions.

EP 1 801 050 A1 discloses an apparatus for de-stacking books, brochures, book blocks or similar cuboidal printed products, comprising a separating belt which is operated by an adjustable drive and is intended to cyclically separate the respective printed product that is at the very bottom from the stack, comprising lateral delimiting means that can be set according to the format and position the stack on the separating belt, comprising a height-adjustable retaining element which forms a passage for the respective printed product to be separated, comprising a support in the run-in region of the separating belt for supporting the rear edge of the printed product that is second from the bottom as the printed product that is at the very bottom is being separated, and comprising a feeding belt which is upstream of the separating belt and is intended to feed a subsequent stack into the separating position.

For the reliable and satisfactory separation of in particular thick, small-format book blocks from high stacks, this de-stacking apparatus has at least one support element which is located at a defined distance behind the stack and can be moved out of the conveying path when a subsequent stack is being fed in. When a subsequent stack is being fed in, the support element automatically moves onto the conveying path.

The stack of book blocks is located on the transporting belt; the hold-down means and the retaining means are advanced, which is to say brought into position (step 1). The transporting belt draws the product that is at the very bottom out of the stack (step 2), whereupon the stack falls onto the conveyor belt (step 3). Then, the retaining means is set to the next product thickness, which de-stacks the next product (step 4). The cycle is repeated until the stack is completely de-stacked.

If the required production cycles are intended for continual supply to a downstream high-performance machine for part-processing or finishing of the products, the impressive de-stacking device, which because of the system is linked to the retaining element, comes up against its limits.

This is related to the fact that, once the first product has been separated (step 3), there is not enough time for the retaining means to be set to the next thickness, because as intended the transporting belt is in continuous operation. The present inventors have recognized that, for kinematic reasons this, constellation runs the inherent risk that in that case two products are de-stacked, and this is not useful for the finishing. The present inventors have also recognized that, by exploiting all the kinematic options, however, it will be found that this de-stacking device can be readily provided for use with book blocks that always have the same product thickness, and in the best case can even be used if the product thickness continuously increases in the course of the de-stacking. The need these days, however, is to ensure a de-stacking of book blocks that have consecutively variable thicknesses.

The general prior art has also disclosed a de-stacking system in the case of which, in a process made dynamic, the book blocks are offset into a skewed position on a swivel table transverse to the production direction. This swivel table has a number of studs which hold the bottom book block of the stack by pressure/friction, and the top book block falls down owing to the gravitational force applied as a result of an implemented movement. In terms of the design, this de-stacking is based on the separation (also referred to as singulation) of two book blocks, but the holding by studs that underlies this idea does not allow thin products to be de-stacked reliably.

The general prior art has disclosed a further de-stacking system, in the case of which the bottom printed product (book block) is moved in the production direction in operative connection with a vacuum plate and a slide arranged on the rear side. A retaining means ensures that the products on top are not separated out as well. The book block is then delivered onto a downstream transporting belt by a transporting roller. This configuration has shown that the entire weight of the stack acts on the printed product that is to be separated owing to the horizontal predefined position. This then means that, in order to prevent thin products from slipping through, the retaining means provided there must be set very precisely, and this is very difficult to bring about in a “book-of-one” mode, because the exact thickness is not known.

### SUMMARY

In an embodiment, the present disclosure provides an apparatus for separating printed products that have been assembled into a stack. The apparatus includes: at least one conveyor, which is configured to be operated by a drive and is configured to transport the stack, the conveyor being operatively connected to at least one advanceable element, which is configured to be used to implement separation of the printed products in the stack in cycles; and at least one sensor, which is configured to detect a width of the stack or of an individual printed product in the stack while the stack is being transported in a transporting direction along the conveyor. The width is taken as a basis to advance a first element, which is configured to assist and/or guide the stack in the transporting direction, with the result that the stack can be transported along the conveyor as far as an end position. A suction force can be exerted on the printed product that is at the very bottom of the stack. In this position, the conveyor can be shifted into a vertically directed inclination. After the inclination has been performed, the first element can be moved backwards, carrying along the rest of the stack, until the printed product that is at the very bottom and is fixed by suction force rests freely. This printed product can be supported by an intermittently operable plate. The printed product can be transported onwards with simultaneous deactivation of the suction force. The subsequent printed products of the stack can be separated and transported onwards in the same way.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows one possible sequence of facilities and machines in which the de-stacking apparatus is integrated;

FIG. 2 shows the embodiment of a first concept of such a de-stacking apparatus;

FIG. 3 shows the configuration of the auxiliary elements in relation to the de-stacking apparatus as per FIG. 2 for taking in various dimensions of the book blocks;

FIGS. 4A-4J show a sequence of the individual method steps for operating a de-stacking apparatus according to a second concept;

FIG. 5 shows a de-stacking apparatus according to a second, expanded concept; and

FIGS. 6a-6b show the design of a central element for reliable de-stacking of book blocks characterized by various forms.

### DETAILED DESCRIPTION

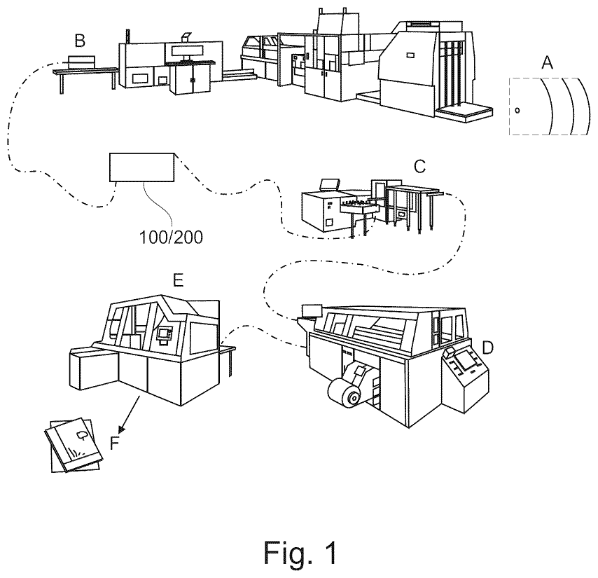

Reference is now made to FIG. 1 in order to describe a possible sequence of facilities and machines for the production of book blocks, which can have various designs. The configuration starts with the representation of a printed paper web (A), which forms the paper basis for the production of book blocks.

Following the provision of the paper web (A), there is a production facility (B), which in this case and by way of example is represented by a high-performance facility, which ensures the basis for a highly efficient output. Such an output is taken on by downstream provisions. For one thing, the book blocks are continuously assembled into stacked units; for another thing, after that there is intervention by a de-stacking apparatus 100, 200, . . . , which ensures that the finishing of the book block is provided via the various downstream machines, for example an endsheet feeder C, adhesive binder D, three-knife trimmer E, in compliance with the cycle. The three-knife trimmer E in the last instance ensures the final finishing of the book blocks F provided by the adhesive binder, irrespective of their thicknesses and sizes. The high throughput via the aforementioned production facility B can be efficiently maintained when the order of the stacking is a strict requirement for the individual finishing of the book blocks, i.e. the de-stacking apparatus 100, 200, . . . is constructed such that the predefined order of the book blocks in the stack, starting at the bottom, is maintained, i.e. the unstacking accordingly firstly takes the book block that is at the very bottom out of the stack, while continuing to comply with the underlying processing cycle at the following stations (C, D, E) and taking into account the different dimensions of the book blocks that are to be processed.

The present inventors have also recognized, with regard to the design of the transporting rollers, to take meticulous care to ensure that they are set, or advanced, precisely on all sides, because if the positioning is not precise or not fixed to a strong enough extent, it is not possible to ensure effective separation of the product. However, the inventors have also recognized not to set, or advance, the transporting rollers to an excessive extent, because this then has a negative effect on the rolling movement of the printed products. Optimum compliance with these conditions is in itself difficult to bring about, since the clean separation of printed products of different thicknesses greatly depends on whether, in the course of this separation, they exhibit a tendency to slip forwards, and thus invalidate the function of the retaining element through an emerging clamping action.

The present disclosure remedies this. Aspects of the present disclosure are based on the object of providing an apparatus and a method for operating same by means of which, with optimized numbers of cycles and irrespective of the respective supplied thicknesses and dimensions of the individual printed products (sometimes in the following text also referred to as book blocks), reliable conveyance onwards is ensured; whether multiple printed products are supplied in a stack or whether the printed products can intermittently also be supplied separately, in both cases the structured separation and conveyance onwards are to be ensured by the same apparatus.

The present disclosure covers two fundamental concept designs on the basis of a stacked position of the printed products, these aforementioned concepts generally being used individually, and it is evident that these concepts have a common technical basis as regards supply. They can also, as and when required, be connected one after another or in parallel with one another, or even be subject to a certain exchange of relevant elements among one another.

The concepts brought into focus here also have the advantage that not only does their operation work with stacked printed products, but they are also continuously capable of taking on production operations in which, intermediately, individual printed products are supplied, which can maximize the flexibility of the concepts.

The mode of operation of a first concept consists in the stack of printed products initially being conveyed by a transporting belt onto a swivel table (steps 1-2), and in the process a light barrier detects the start and the end of the stack. The defined, and thus known, speed of the transporting belt makes it possible to ascertain the stack width. Then, the information about this width can be taken as a basis to set the format by directly advancing a slide. During the subsequent procedure (step 3), the slide moves upwards to the rear of the stack. This makes it possible for the stack to be conveyed forwards along the swivel table in the conveying direction by this very slide as far as a vacuum position at the end of the swivel table (step 4), wherein, in this vacuum position, the product that is at the very bottom of the stack is held in place by the suction force acting there, so that the swivel table can now assume its implemented inclination. At the same time, there is also the fact that the entire stack is stably held in this position by a rearwardly acting and vertically deployed slide. From this position, the next operational implementation is then performed by moving this slide backwards, as a result of which the rest of the stack is returned in ordered fashion on the skewed plane (step 5). The support of the stack by the slide which is movable in the transporting direction can advantageously always be provided in order to ensure an ordered position of the rest of the stack. In addition, in this constellation, after step 5 action is taken by a plate which is intermittently operable from below and is directed at the made-available printed product for transport onwards, to the extent that this plate ensures that in particular thick and heavy printed products cannot fall apart immediately after the separation process. Therefore, the remaining stack is separated owing to the printed product held force-fittingly by the vacuum effect, which makes it available autonomously in displacement terms. Between the two entities, a tappet is moved upwards (step 6) and at the same time the vacuum on the printed product that was at the very bottom is removed. Therefore, the printed product that was at the very bottom has a positionally stable and at the same time conveyable constellation, so that it is now possible for the slide to be able to re-shift the stack back to the vacuum position, and at the same time the printed product that was at the very bottom is conveyed onwards (step 7), which makes the remaining stack available for the next de-stacking operation (steps 1-7). A light barrier at the slide identifies whether there are still printed products in the stack, and after the de-stacking has finished, stacked printed products are fed in anew.

The advantages of this first concept are as follows:
a) no mechanical setting is necessary as regards the thickness of the printed products, and accordingly it is possible to work with a stack of printed products of completely variable thicknesses (book-of-one).
b) It is not necessary to provide any information in advance about the composition of the stack as regards the number of products, product thickness, format.
c) The skewed position reduces the load on the printed products that are to be de-stacked, the result of this being a considerable advantage for the de-stacking process.

To take in different formats of the printed products, the swivel table according to the preceding first concept is designed such that the stack that is fed in can slide from the feeder structure onto the swivel table to the maximum extent without resistance. The swivel table is designed such that the printed products can be guided through. Between a minimum format (block height 120 mm/block width 100 mm) and a maximum format (block height 380 mm/block width 330 mm), printed products can be guided through. Both the auxiliary elements that are part of the swivel table and the plate positioned at the end for generating the vacuum force exerted on the printed product allow at least the listed minimum/maximum format to be taken in, and furthermore this swivel table still has operative reserves that allow the formats to be further minimized or maximized, respectively, it being possible in the case of this swivel table furthermore to take in printed product thicknesses at least between 1.5 and 65 mm. With a conventional cycle frequency, across all dimensions of the printed products, it is possible to achieve production runs of at least 4000 units per hour. Even in the case of “book-of-one” operation, i.e. every printed product in this case has different dimensions and shape than the others, cycle frequencies of at least 2000 units per hour can be achieved, and therefore from these numbers it is very clear that the de-stacking according to the present disclosure in the individual concepts set out here is a significant enhancement of the prior art.

A further concept according to the present disclosure for de-stacking of stacks formed by printed products, which set-up is used in particular for higher numbers of cycles, whether it is an autonomous set-up or a set-up in conjunction with the de-stacking of the concept set out above, it being possible to readily imagine that the de-stacking according to the first concept can be used for a “book-of-one” production, and the rest of the production run can then be executed using the second concept, the latter then being able to continuously produce larger batches. This combined mode of operation can be considered whenever the concepts are used in parallel and whenever in that case, although the “book-of-one” approach is used intermittently, it is done at a high rate.

The de-stacking according to this second concept is executed using the following steps.

The stack is conveyed onto the infeed belt, which corresponds to the transporting belt of the de-stacking according to the first concept. This stack is initially deposited on an intermediate platform and is then available for onward transport. It is thus possible, when such an intermediate stage is provided, for the stacks to be kept on the transporting belt, if it is not possible for the de-stacking according to the second concept to cope with the inflow of printed products.

Then, the stack is transferred to an overhead transporter, which is moved in position relative to a take-up apparatus which is transferred into a position for optimally taking up the stack. A light barrier, not shown in more detail, which detects the stack width, or the width of the printed products, is active here as well. This take-up apparatus is designed in kinematic terms such that a movable, directly acting receiving element can run the same take-up apparatus up towards the overhead transporter (stack lift), be aligned for the taking-up operation and there accordingly take up the supplied stack. In continuous operation, for cycle-maintaining reasons it is also possible for the stack, or the printed products in general, to in each case be brought directly by the overhead transporter up to the receiving element which performs the function of a stack lift, as described in more detail below.

In the further course of the procedure includes the direct transfer of the stack provided by the overhead transporter, this transfer needing to be matched taking into account the relative movement between the bearing means and the take-up means, significant assistance for the taking-up operation being provided in that the run-up receiving element is fitted with a lateral guiding and stabilizing wall, via which the stack can be slid into the receiving element. The further fitting of the take-up apparatus, with the stack taken in by the receiving element, takes place only when the book blocks introduced beforehand have been conveyed on individually.

An intermediate starting position is effected by direct take-up by the overhead transporter. The stack lift brings the stack from the magazine into the separation position of the take-up apparatus by a linear movement and rotation, so that the separation process can then be started by moving the stack lift upwards to take up the stack, so that the next stack can be picked up directly at the overhead transporter. A pusher dog chain brings the separated product into a horizontal or virtually horizontal position for conveying purposes. During the described separation (de-stacking) of the stack, this stack is transferred into a separation position, the previously separated printed product being conveyed by means of the aforementioned pusher dog chain onto the transfer belt, where it then can be transferred to the subsequent transporting belts.

The advantages of this second concept are as follows:
a) the skewed position reduces the load on the printed product that is to be de-stacked, this being a considerable advantage for the de-stacking process.
b) The retaining means and the support thus do not need to be exactly set to the product thickness.
c) The separation by means of a servo-drive axis enables great flexibility of the system. This makes it possible to shake loose, or twice loosen, the printed products in the assembly.
d) Since the printed product is separated completely by the servo-drive axis, it is possible e.g. even when the axis is moving in reverse for a previously advanced product to be identified and immediately picked up at this location.
c) The infeed and the separation are decoupled from one another. A new stack can be guided up during the separation, and this has a positive effect on the output efficiency.

An aspect of the present disclosure may therefore involve a first concept, which involves an apparatus and a method for separating printed products, such as books, book blocks, brochures, that have been assembled into a stack, and conveying means (conveyor, e.g., a swivel table) that can be operated by a drive and are for transporting the stack, the conveying means being fitted with at least one advanceable element, which can be used to implement separation of the printed products in the stack in cycles. When the stack is being transported in the transporting direction along the conveying means, at least one sensor detects the width of this stack or of the individual printed product, and this stack width is taken as a basis to advance a first element which serves to assist and/or guide the stack in the transporting direction. The stack is carried along the conveying means as far as an end position, in which a suction force is exerted on the printed product that is at the very bottom of the stack. In this position, the conveying means is shifted into a vertically aligned inclination, and after the inclination has been performed, the first element can be moved backwards, carrying along the rest of the stack, until the printed product that is at the very bottom and is fixed by suction force rests freely. This printed product is then supported by an intermittently operable plate, which transports the printed product onwards with simultaneous deactivation of the suction force, wherein the subsequent printed products of the stack can be separated and transported onwards in the same way. The intermittently operable plate is aligned with the printed product separated for transport onwards, the retracted plate serving to secure thick and heavy printed products against falling apart.

Furthermore, also still in the sense of a summary of the second concept, the apparatus and the method for separating printed products, such as books, book blocks, brochures, that have been assembled into a stack are equipped with at least one transporting device and a de-stacking apparatus, in which it is possible to separate the printed products in cycles, wherein a transporting device is designed to take up a stack made available by a transporting belt, and the transporting device carries the stack to the level of a de-stacking apparatus located underneath. A light barrier in the region of the transporting device detects the stack width and/or the width of the individual printed products and forwards this information to the de-stacking apparatus. A receiving support which is part of the de-stacking apparatus is moved from an operating position upwards towards the transporting device, until a position in which the stack is transferred from the de-stacking apparatus to the receiving support is reached. The receiving support with the taken-up stack moves back to its operating position, in which the de-stacking operation is then initiated. In the meantime, the transporting device moves back to its starting position to take up a subsequently supplied stack. In this operating position, action is taken by at least one force-generating retaining means, which exerts a holding force on the top of the stack, on the bottom of the stack, or on at least one printed product above the printed product that is at the very bottom. The printed product that is at the very bottom is taken in by a conveying belt operating below the receiving support and transported onwards by means of a pusher dog in the form of part of a pusher dog chain. The rest of the printed products are successively released by the retaining means, and they are then transported onwards individually in the same way.

Further, still in the sense of a summary of a now expanded second concept, the apparatus and the method for separating printed products, such as books, book blocks, brochures, that have been assembled into a stack are equipped with at least one transporting device and a de-stacking apparatus, in which it is possible to separate the printed products in cycles. A transporting device is designed to take up a stack made available by a transporting belt, and the transporting device carries the stack to the level of a de-stacking apparatus located underneath. A light barrier in the region of the transporting device detects the stack width and/or the width of the individual printed products and forwards this information to the de-stacking apparatus. A receiving support which is part of the de-stacking apparatus is moved from an operating position upwards towards the transporting device, until a position in which the stack can be transferred from the de-stacking apparatus to the receiving support is reached. The receiving support with the taken-up stack moves back to its operating position, in which the de-stacking operation is initiated. In the meantime, the transporting device moves back to its starting position to take up a subsequently supplied stack. In this operating position, action is taken by at least one force-assisted retaining means, which applies a vacuum force which is exerted on the respective printed product that is at the very bottom and which can be briefly deactivated when this printed product is conveyed onwards, to temporarily be re-activated for the next printed product that is moved up. The printed product that is at the very bottom is in each case, after it has been de-stacked, transferred directly to a further conveyor belt, this conveyor belt being operatively connected to a pusher dog chain acting on the printed product, and the two being operated autonomously, so that the pusher dog chain can thereby ensure the conveyance onwards of the printed products in cycles. The rest of the printed products are successively released by the retaining means, and they are transported onwards individually in the same way.

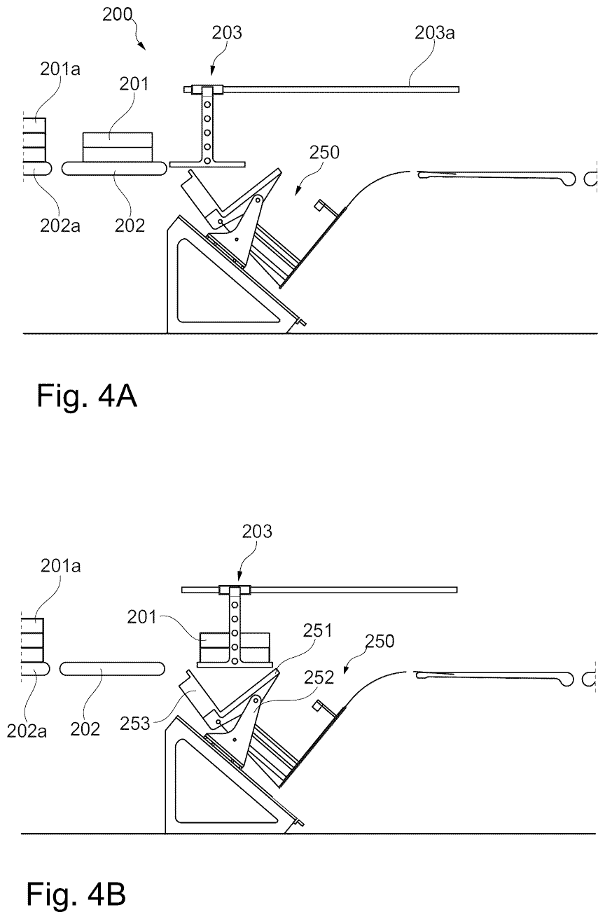

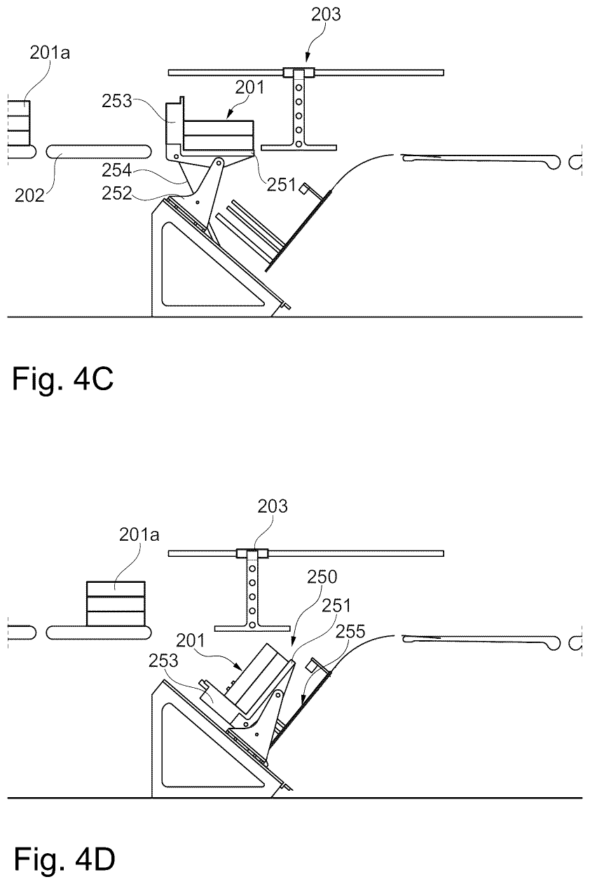

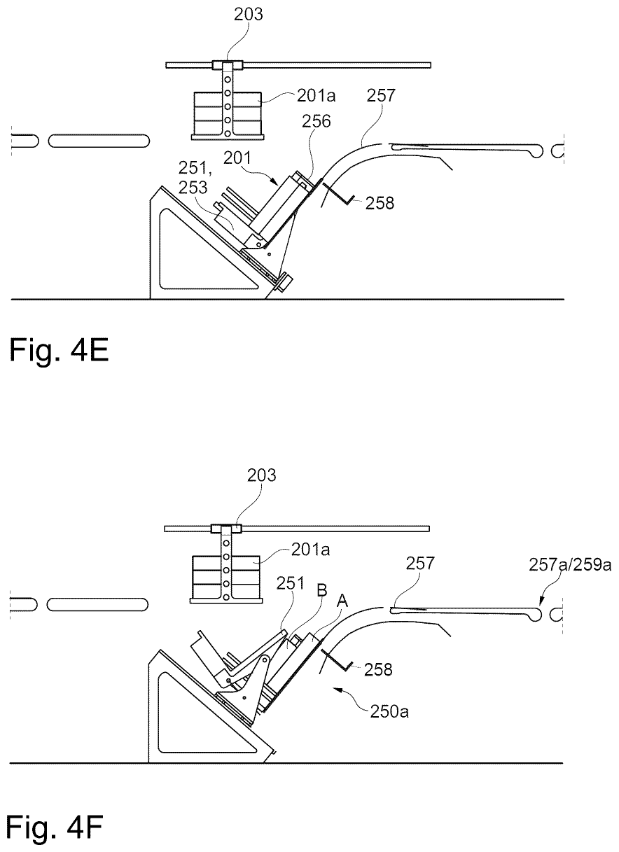

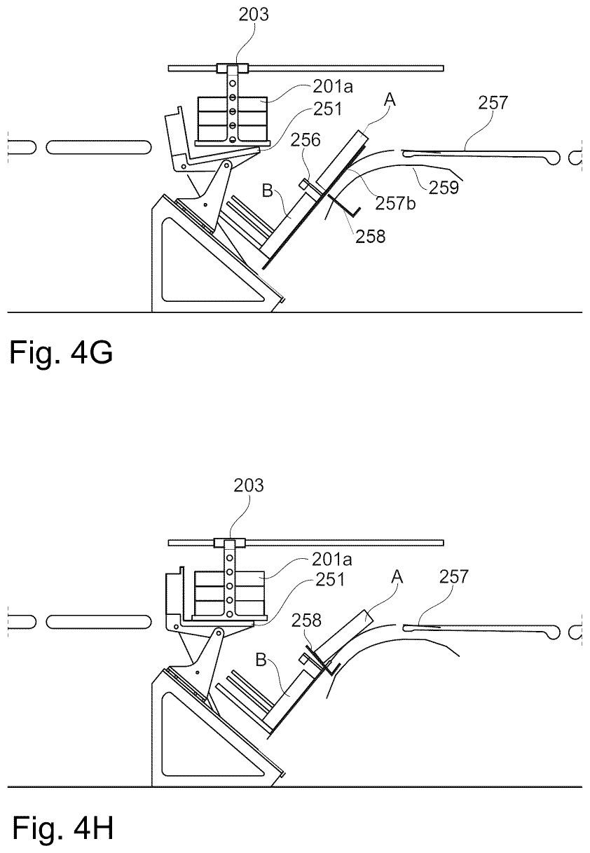

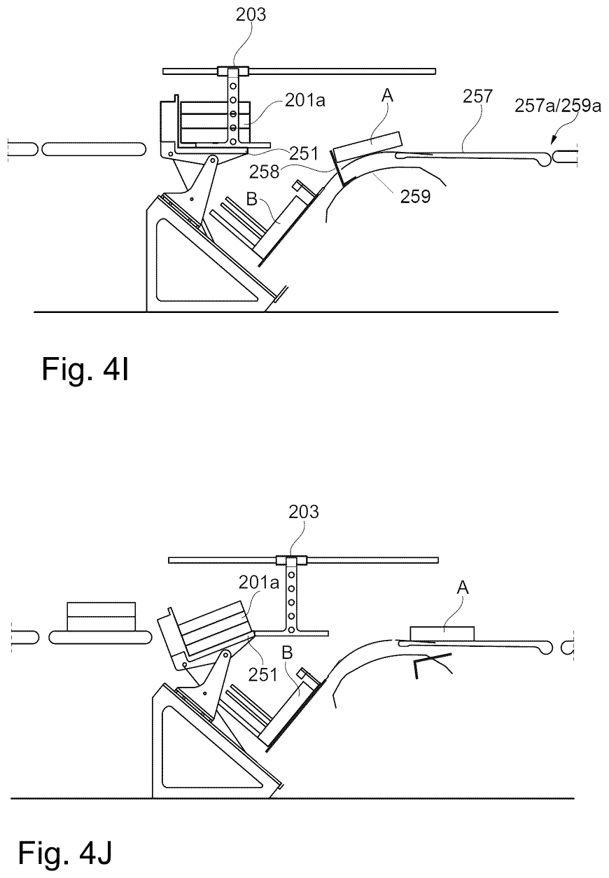

In principle, it is the case that the de-stacking apparatus according to the second concept can be operated in two ways (concept 2 and expanded concept 2): As regards FIGS. 4.5 and 4.6, the de-stacking apparatus is handled by a de-stacking operation which is based on the fact that it is conducted importantly by a preferably mechanically operable retaining means, i.e. the separation and onward transport of the respective printed product that is at the very bottom is ensured during this phase only by the use of this very retaining means, by the latter pressing against the upper printed products. The printed product that is at the very bottom is otherwise not impeded by further provisions.

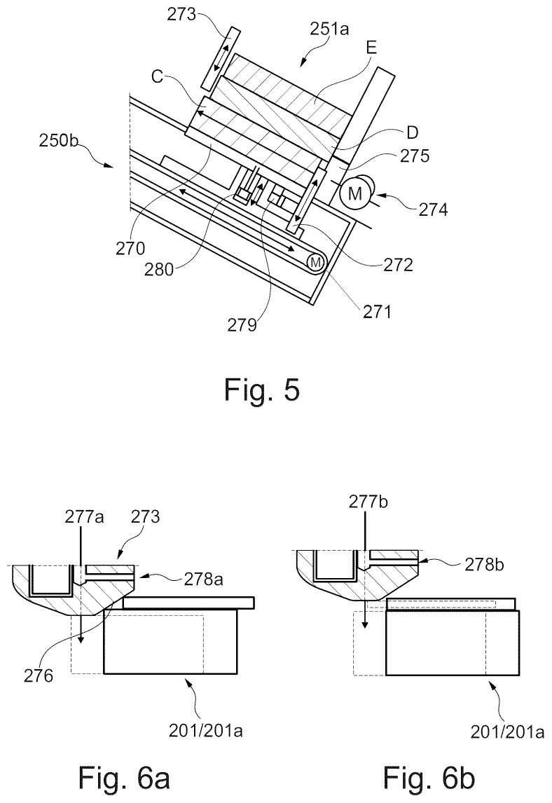

Otherwise, the de-stacking apparatus is operated when the de-stacking operation is executed according to FIGS. 5, 6a, 6b, to which reference is made here to avoid unnecessary repetitions, this concept according to the present disclosure (expanded concept 2) coming fully to the fore when it is necessary to ensure a production run with high numbers of cycles but quickly changing dimensions, thicknesses and make-ups of the book blocks.

In the following text, the present disclosure will be explained in more detail with reference to the drawings. All elements that are not essential for the immediate understanding of the present disclosure have been omitted. Identical elements are provided with the same reference signs in the various figures.

FIG. 1 shows, for the sake of better understanding, the scope of the present disclosure in the form of a possible sequence of facilities and machines for the production of book blocks of various configurations. The configuration starts with the representation of a printed paper web A, which forms the paper basis for the production of book blocks. Following the provision of the paper web A, there is a production facility B, which in this case and by way of example is represented by a high-performance facility (Sigmaline) from the applicant's company, which ensures the basis for a highly efficient output. It is obvious that this output needs to be taken on by downstream provisions. For one thing, the book blocks are continuously assembled into stacked units; for another thing, after that there is intervention by a de-stacking apparatus 100, 200, . . . , which ensures that the finishing of the book block is provided via the various downstream machines, for example an endsheet feeder C, adhesive binder D, three-knife trimmer E, in compliance with the cycle. The three-knife trimmer E in the last instance ensures the final finishing of the book blocks F provided by the adhesive binder, irrespective of their thicknesses and sizes. The high throughput via the aforementioned production facility B can be efficiently implemented only when the order of the stacking is a strict requirement for the individual finishing of the book blocks, i.e. the de-stacking apparatus 100, 200, . . . must be constructed such that the predefined order of the book blocks in the stack, starting at the bottom, is maintained, i.e. the unstacking must accordingly always firstly take the book block that is at the very bottom out of the stack, while continuing to comply with the underlying processing cycle at the following stations (C, D, E) and taking into account the different dimensions of the book blocks that are to be processed.

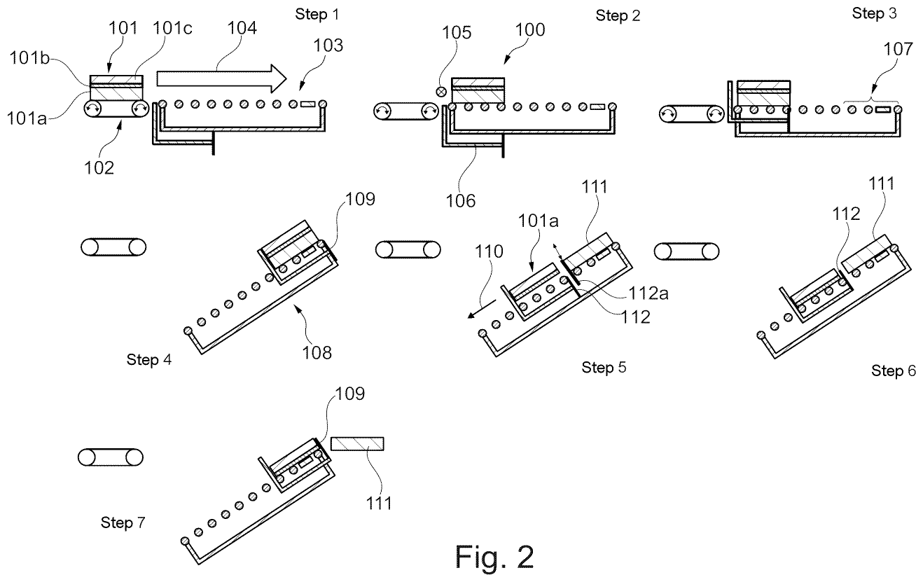

FIG. 2 shows a first embodiment of a de-stacking apparatus 100, the sequence performed by which being that firstly, the stack 101 of book blocks is conveyed by a transporting belt 102 to a swivel table 103 in accordance with a predefined material flow direction 104 (steps 1-2), as is evident from the steps 1 and 2 shown. In the process, a light barrier 105 detects the start and the end of the stack 102, the simultaneously raised or defined speed of the stack in the material flow direction establishing the stack width. Owing to this ascertainment of the width of the stack, it is possible to punctually stipulate in good time the advancement of a slide 106 initially resting in the inactive state. In the following procedure (step 3), the slide 106 moves upwards to the rear of the stack 101 and assists same in its onward transport, which is characterized by a backward movement, so that the stack specifically is not damaged in terms of stock by this guided movement. Owing to said slide 106, the stack in its onward transport is provided with effective accompanying support, this slide being coupled to the transporting movement of the swivel table 103 or assisting the continued movement of the stack within certain limits by means of a dedicated drive. In the latter embodiment, the de-stacking can be kept up even if the motor function of the swivel table 103 fails.

Then, the stack is guided up to a determined position 107 at the end of the swivel table (step 3), in which position it is force-fittingly taken in by a controllable suction force (step 4), whereupon applied to the book block 111 that is at the very bottom (see step 5), owing to the suction force acting there, is a force fit which lasts as long as the controllable suction force is operating. In this stabilized starting position of the stack, both as a result of the use of the slide 106 and as a result of the acting force fit, the predefined upwardly directed inclination 108 of the swivel table can be carried out, this inclination constituting a further starting position for the de-stacking, in the case of step 4 of this figure reference being made to a stop 109, which takes action intermittently and is operatively connected to the slide 106 (see step 7), which holds the stack as before stably in place, and therefore there is also no risk that the upper part of the stack, except for the book block that is at the very bottom, can slide down backwards, as is evident from step 4. The next operational implementation of the de-stacking operation is done by selective procedures, by said slide 106 performing, in the inclined position 108 of the swivel table 103, a backward movement 110 which acts on the book blocks of the rest of the stack in that the stack also follows the backward movement of the slide, as is evident from step 5. This makes the technical relevance of the slide 106 in operative connection with the integrated tappet 112 clearly evident, in particular if it is assumed that this de-stacking can also be used for heavy book blocks, since an unordered slipping backwards of the book blocks of the rest of the stack would make the subsequent de-stacking considerably more difficult. Given these circumstances, further support relating to the onward transport of the book block 111 that was at the very bottom is provided: Here, action is taken by a plate 112a which is intermittently operable from below (its movement is indicated by arrows) and is directed supportingly at this book block, so as to ensure that in particular thick and heavy book blocks do not fall apart after the separation process. After the sub-stack 101a has been completely separated, a tappet 112 aligned with the position of the latter book block 111 is moved upwards (step 6) between the front edge of the rest of the stack 101a and the rear edge of the book block 111 force-fittingly taken in there. There is therefore an effective separation between the rest of the stack 101a and the force-fittingly taken-in book block 111, which in turn is a starting point for the further operations of the de-stacking, specifically that the suction force acting on the book block is intermediately deactivated, as a result of which the book block can be conveyed onwards, generally by activation of the swivel table for transportation, the tappet 112 resting in position until the rest of the stack 101a has come into abutment there, in order that there is no interference with the initiated onward conveyance of the released book block 111 (step 7), this operation also being monitored by a further light barrier. After the tappet 112 has been retracted again, the dynamics are used for the further de-stacking (step 7), in turn starting with the book block that is at the very bottom (steps 1-7), this subsequent displacement of the stack being determined in terms of position by the activated slide 109.

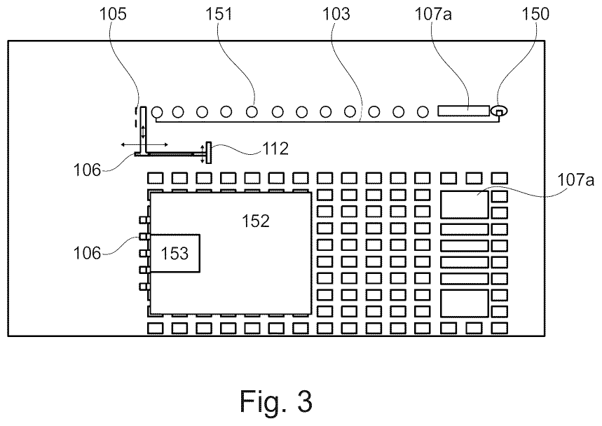

The upper part of FIG. 3 shows the stylized configuration of the swivel table 103 according to FIG. 2, while the lower part shows a plan view of the tabletop. The illustrated configuration of the tabletop is configured such that different formats (width/height) of the stack formed by the book block (see FIG. 2) can be continuously processed. This FIG. 3 shows the layout of the rollers 151, here preferably in the form of lifting cart rollers, which ensure that the stack (see FIG. 2) can slide smoothly from the feeder structure onto the swivel table 103. Also indicated here is the axis of rotation 150 of the swivel table 103, this axis allowing the inclination described under FIG. 2. It is also the case here that the kinematic movements of the slide 106 and of the tappet 112 are indicated by arrows, which in operative connection relative to one another conjointly make it possible to implement the de-stacking when various dimensions of the book blocks are to be taken in. To this end, accordingly, at the top of the swivel table 103 there is a series of mutually spaced slides/tappets 106/112 that are displaceable between the tracks formed by the rollers 151. A first variant is that in each case the entire group of slides/tappets is actuated, irrespective of the present dimensions of the book block; in a further variant, the number of the respective activated slides/tappets depends on the present block width of the book block: in the case of a minimum format, for example 1-2 sliders/tappets; in the case of a maximum format, the entire group is used at the same time.

Between a minimum format 153 (block height 120 mm/block width 100 mm) and a maximum format (block height 380 mm/block width 330 mm), a broad range of book blocks can be fed through, and at the end of the swivel table there are vacuum plates 107a (see FIG. 2) that have different dimensions and directly exert the suction force on the taken-in book block. The light barrier 105 and its operation are further also shown here. In connection with the processing of different book block formats, additionally a book block thickness of between 1.5 and 65 mm can be fed through without additional provisions, and any provisions that are made will have a more straightforward nature, and therefore they can still be implemented attractively in all cases. With a conventional cycle frequency, across all dimensions of the book blocks, it is possible to achieve production runs of at least 4000 units per hour. Even in the case of “book-of-one” operation, i.e. every book block in this case has an individual form, cycle frequencies of at least 2000 units per hour can be achieved, and therefore from these numbers it is very clear that the de-stacking according to the present disclosure in the individual concepts (FIGS. 2, 3 and 4.1-4.10, 5 and 6a/6b) set out here is a significant enhancement of the prior art.

The dynamic implementation of the second concept 200 of de-stacking according to FIGS. 4A to 4J, which in principle can be used as a basis for the execution of a first de-stacking operation 250a (see FIG. 4.6) and also a second de-stacking operation 250b (see FIG. 5), will be reproduced the following text by means of a structural representation of the sequence of the individual steps, which per se constitute a respective snapshot at a specific point in time of the entire procedure, the resulting sequence as a whole, FIGS. 4A to 4J, making it possible to identify the continuous dynamics of this de-stacking straightaway. The sequence and numbering of the figures have deliberately been selected such that, as a result, direct indications are given about the individual steps of the sequence.

This de-stacking 200 is preferably used at higher numbers of cycles, whether in the form of an autonomous set-up or in conjunction with the de-stacking 100 of the concept according to FIGS. 2 and 3 set out above, it being possible to readily imagine that the de-stacking 100 according to the first concept (FIGS. 2 and 3) can be used for a “book-of-one” production, and the rest of the production run can then be executed using the second concept (FIGS. 4A-4J and 5, 6a/6b), the latter then being able to continuously produce larger batches. This combined mode of operation can be considered whenever there is the option of using the concepts 100, 200 in parallel and whenever, although the “book-of-one” production run is effected intermittently, it is done often.

This de-stacking 200 according to the second concept as per FIGS. 4A-4J bringing in the further FIGS. 5, 6a, 6b, which represent the individual significant steps of the de-stacking, is executed as follows.

FIG. 4A reproduces step 1, the stack 201 being conveyed onto the infeed belt 202a, which corresponds to the transporting belt of the de-stacking 100 (FIGS. 2 and 3). In this starting position, it is evident that the next stack 201 has already taken its position for the next de-stacking cycle. This stack 201 provided for de-stacking is initially transferred to the intermediate platform 202 and is then transferred by further complementary transporting steps for the actual de-stacking, which takes place in the de-stacking apparatus 250. Interposing the intermediate platform 202 as a buffer zone is advantageous whenever the de-stacking apparatus 250 is temporarily not capable of processing the incoming stack 201 in time. Also evident from this figure is the waiting position of the overhead transporter 203, the object of which, as is evident from the following figures and also is yet to be illustrated and described, is to take up the lined-up stack 201 and position it over the extent of the overhead transporter infrastructure 203a such that the de-stacking apparatus 250 then takes action and can be selectively operated.

FIG. 4B shows the further course of the de-stacking to the effect that the overhead transporter 203 now takes up the stack 201 as a result of a transfer procedure, so that the stack is transferred into an optimum position with respect to the de-stacking apparatus 250, i.e. this position is characterized in that the receiving support 251 that is part of the de-stacking apparatus 250 assumes a position which induces the subsequent take-up of the stack 201. The net perpendicular displacement of the receiving support 251 towards the overhead transporter 203 together with the stack 201, which is positioned there ready for the take-up, by running the carrier 252 of the receiving support 251 up along an oblique guide, whereby this slope predefines the angled inclination of the stack during the de-stacking operation. This starting position can be readily used for the determination of the stack width, or the width of the book blocks, by means of a light barrier (see FIG. 3), which is not shown in more detail, and this determination can also be done upstream. The next step relates to the taking in of the stack 201 by running the receiving support 251 up further, and in the further course of the de-stacking, the receiving support performs the function of a stack lift, as represented in more detail in FIG. 4.3.

FIG. 4C shows the directly performed transfer of the stack 201 from the overhead transporter 203 to the receiving support 251, during the transfer the latter being shifted into a horizontal position with respect to the lower plane of the stack 201 by a partial rotation, taking account of the relative movement of the two elements in cyclic operation, receiving support 251/overhead transporter 203, and therefore, for example by means of a lifting device 254, its lateral guiding wall 253 is also aligned into a vertical plane, so that it forms a stop wall with respect to the received stack. Therefore, the receiving support 251 including the guiding wall 253 assumes a configuration which leads to maximum stabilization of the stack 201 as it is transported onwards to the actual de-stacking.

FIG. 4D shows a further position of the stack 201 within the de-stacking apparatus 250, the stack being moved downwards on the way towards the conveying plane 255 for further conveyance of the book block (201) subsequently de-stacked there, the technical sequence of the actual de-stacking being shown and explained in the following figures. It is shown, during this continuation, that the second stack 201a has already taken its position in order to be taken up by the overhead transporter 203 for the further de-stacking cycle.

FIG. 4E shows the direct continuation of the advancement of the stack according to FIG. 4D, so the stack is conducted by the guided guide by means of the receiving support 251 and the guiding wall 253 and has reached its end position, from which then the actual de-stacking (separation) of the book block is initiated. This separation is initially performed by activating a retaining means 256, which stabilizes the book block B which is directly second from the bottom by exerting a counterforce for the purpose of conveying the book block A that is at the bottom onwards, so that the latter book block is unimpededly available, and then can be transported onwards via the operation of a conveyor belt 257, this conveyor belt being operated continuously (see FIG. 4I) and at the same time being in operative connection with a pusher dog chain 259 and pusher dogs 258, which (258) individually convey the book blocks in compliance with the predefined cycle.

FIG. 4F shows the start of the actual de-stacking (separation) of the individual book blocks A, B from the respective stack, after they have been unloaded by the receiving support 251 from the bottom, and it then sets out to take up the next stack 201a in the operation described according to FIG. 4A. The operation of the de-stacking 250b initiated here is explained in more detail in the following figures, the more important embodiment of the second concept being explained in detail in FIGS. 5 and 6.

In principle, it is the case that the de-stacking apparatus 250 of the second concept can be operated in two ways: firstly by a de-stacking operation 250a, in particular illustrated in FIGS. 4E and 4F, and secondly by a differently designed de-stacking operation 250b according to FIGS. 5, 6a, 6b. That is to say, while the de-stacking operation 250a is importantly based on being operated by a preferably mechanically operable retaining means 256, i.e. the separation and onward transport of the respective book block that is at the very bottom is ensured during this operational phase only by means of thus very retaining means 256, by the latter pressing against the products still resting above the book block that is at the very bottom by mechanical means. The now-released book block that was at the very bottom is also otherwise not inhibited by any further provisions. Otherwise, the de-stacking apparatus 250 is operated when the de-stacking operation 250b is implemented according to FIGS. 5, 6a, 6b, these figures being described in more detail below, to which reference is made here to avoid unnecessary repetitions. This de-stacking operation 250b also comes fully to the fore for maximum enhancement of the prior art, primarily because it makes it possible to ensure a production run with high numbers of cycles but quickly changing dimensions, thicknesses and make-ups of the book blocks. The rest of the sequences of the de-stacking apparatus 250 with respect to the latter de-stacking operation 250b can fundamentally also be dealt with by drawing on FIGS. 4A-4F, the sole difference in that case being that the actual separation operations (250a vs. 250b) for separating the book blocks are different, and also are operated differently, the ultimate purposes of the two corresponding to one another.

FIG. 4G in principle shows the separation that has taken place of the book blocks A, B that are part of the relevant stack and are transported onwards individually and in subsequent cycles on the transporting belt 257 by means of a respective pusher dog 258 of the pusher dog chain 259. In the case of this partial operation, it is also evident that the receiving support 251 is now ready for the take-up of the next stack 201a, and this describes the position already illustrated under FIG. 4B. In this starting position, the retaining means 256 assumes a neutral position, as a result of which the initially lined-up book block can be freely conveyed, firstly via a transition section 257b and subsequently then via a straight transporting belt 257, where the book block is taken in by the next pusher dog 258 of the pusher dog chain 259 in accordance with the cycle. The basis for this is as follows: both the transporting belt 257 and the pusher dog chain 259 are operated independently. The pusher dog chain 259 takes up the product from the separation (de-stacking) and brings it into the horizontal position, where the product is taken up by a subsequent conveyor belt. This conveyor belt is also operated independently.

FIG. 4H shows the continuing continuation of the separation of the book block A, B, according to the description under FIG. 4G, the first book block not being in abutment with application of force with the pusher dog 258, so that cyclically reliable conveyance onwards via the transporting belt 257 is ensured. At the same time, the receiving support 251 is now ready for the take-up of the next-supplied stack 201a. In this case, for de-stacking purposes, there is then a larger number of book blocks than the previous stack 201 had, and this has not changed at the end of the de-stacking itself, according to the preceding figures. This is also evident from FIGS. 5 and 6.

FIG. 4I shows the onward conveyance of the initially separated book block A, and also the complete take-up of the subsequent stack and the schematic indication of the continuous conveyor belt 257a, with respect to the conveyor belt 257, with simultaneous involvement of the pass 259a, with respect to the pusher dog chain 259, the transporting belt 257 and the pusher dog chain 259 being operated autonomously.

FIG. 4J shows the further course of the separation of the book block A, B, this figure showing that the last book block B of the first stack 201 being in the process of leaving the de-stacking apparatus 250, so that the incoming new stack 201 can be introduced without interruption for separation according to the preceding figures.

In the present case, for practical reasons FIGS. 5, 6a and 6b will be described together. FIG. 5 shows a de-stacking operation 250b for the book blocks, which by contrast to the previous de-stacking operation 250a, as illustrated in particular in FIGS. 4E and 4F, provides protection for a further benefit according to the present disclosure, it also being the case for the expanded embodiment (250b) of the second, expanded concept that the relevant operations in FIGS. 4A-4J are applied, if it is a matter of ensuring the transportation and placement of the printed products, and therefore in the present case it is not necessary to discuss these aspects again.

The stack according to FIG. 5 in this case consists of three book blocks C, D, E, corresponding to the stack 201a in the preceding figures, it being possible importantly for there to be more book blocks at any time. In accordance with the underlying separation process (de-stacking) in this case, the entire stack is offset into a skewed position in order to reduce the frictional force acting on the book block that is to be separated. The book block C that is at the very bottom of the stack is held by a curved vacuum plate 270 and separated from the stack by a servo-drive axis 271, this servo-drive axis allowing a shaking loose in the sense of a twofold loosening up. A support 272 ensures that the products are not damaged in the course of this process, it having emerged that a support is required from a book block thickness of approximately 30 mm. A retaining means 273 ensures that the products D, E on top of the book block C that is at the very bottom during the de-stacking operation 250b cannot be conjointly affected or skewed.

A stop 275 operatively connected to a vibrator 274 loosens the stack and also ensures that the desired alignment of the book block is assisted. The geometry of the variable-thickness retaining means 273 also ensures that a chamfer 276 thereof in the direction of the separation is available and takes action if there is a certain inexactness in the book block thickness, in order that this does not unacceptably inhibit the further operation. There could be limits to this offset if there are successive book blocks with extreme thicknesses. In order to also be able to continuously offset them, the retaining means 273 according to FIG. 6a is supplemented by the aforementioned chamfer 276, which is set slightly lower down than the book block thickness, so that the book block can then be forced through under the retaining means 273. A thin product lying thereon could thus be held back. If the retaining means 273 according to FIG. 6b, by contrast, is set slightly too high, the risk that a thin product can slip back increases. This is remedied by throughflow openings 277a, 277b being on the side in the direction of the stack, through which blown air 278a, 278b acting on the stack, or book block, is fed to relieve the loading thereon, and this can effectively offset the variable thicknesses of the book blocks of the various stacks 201, 201a. The process sequence is fundamentally designed according to the sequences as described according to the first or the second concept, to which reference is made to avoid unnecessary repetitions, and in the case of this second concept further elements, such as the vibrator 274, thickness information via BC reader 279, curvature of the lifting table 270 and its suction force implementation 280 can be incorporated that increase the quality of the separation process.

The de-stacking operation according to the second, expanded concept according to FIGS. 4A-4J, 5, 6a, 6b can also be carried out by means of a configuration for exerting a vacuum force on the book block that is at the very bottom according to the description according to FIGS. 2 and 3, if need be as and when required using a retaining means according to FIG. 5, reference sign 273 or FIG. 4E, reference sign 256.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An apparatus for separating printed products that have been assembled into a stack, the apparatus comprising:
at least one conveyor, which is configured to be operated by a drive and is configured to transport the stack, the conveyor being operatively connected to at least one advanceable element, which is configured to be used to implement separation of the printed products in the stack in cycles; and
at least one sensor, which is configured to detect a width of the stack or of an individual printed product in the stack while the stack is being transported in a transporting direction along the conveyor,
wherein the width is taken as a basis to advance a first element, which is configured to assist and/or guide the stack in the transporting direction, with the result that the stack is being transported along the conveyor as far as an end position,
wherein a suction force is exercisable on the printed product that is at the very bottom of the stack,
wherein in this position, the conveyor is being shifted into a vertically directed inclination,
wherein after the inclination has been performed, the first element is movable backwards, carrying along the rest of the stack, until the printed product that is at the very bottom and is fixed by suction force rests freely,
wherein this printed product is supported by an intermittently operable plate,
wherein the printed product is being transported onwards with simultaneous deactivation of the suction force, and
wherein the subsequent printed products of the stack are separable and transportable onwards in the same way.

2. The apparatus according to claim 1, wherein the conveyor is a swivel table.

3. The apparatus according to claim 1, wherein the intermittently operable plate is aligned with the printed product that has been separated for transport onwards, and wherein, owing to the deployed plate, thick and heavy printed products are kept from falling apart.

4. The apparatus according to claim 1, wherein the individual printed products are configured to be subsequently fed via a transporting belt in operative connection with an autonomously operable pusher dog chain of a finishing machine.

5. An apparatus for separating printed products that have been assembled into a stack, the apparatus comprising: at least one transporting device and a de-stacking apparatus, which is configured to separate the printed products in cycles, the apparatus further comprising:
a) a transporting device configured to take up a stack made available by a transporting belt, the transporting device being further configured to carry the stack to the level of a de-stacking apparatus located underneath;
b) a light barrier or a sensor in the region of the transporting device that is configured to detect a width of the stack and/or of the individual printed products and to forward this information to the de-stacking apparatus;
c) a receiving support, which is part of the de-stacking apparatus, and which is configured to be moved from an operating position perpendicularly or virtually perpendicularly towards the transporting device, until a position in which it is possible to transfer the stack from the de-stacking apparatus to the receiving support is reached;
d) a receiving support with the taken-up stack moves back to its operating position, in which a de-stacking operation is being initiated;
e) in the meantime, the transporting device moves back to its starting position to take up a subsequently supplied stack;
f) in this operating position, at least one mechanically driven retaining means takes action to carry out the de-stacking operation and is able to exert, at a suitable position, a force on at least one printed product above the printed product that is at the very bottom, this force then making it possible to transport the printed product that is at the very bottom onwards unimpeded;
g) after that, a conveyor belt operated underneath the receiving support is feasible to collect the printed product that is at the very bottom and transport it onwards by means of a pusher dog chain equipped with pusher dogs;
h) the rest of the printed products are successively released by the retaining means, and they is being transported onwards individually in the same way.

6. The apparatus according to claim 5, wherein the conveyor belt and the pusher dog chain are operable autonomously.

7. The apparatus according to claim 5, wherein the transporting device is in the form of an overhead transporter.

8. The apparatus according to claim 5, wherein the receiving support for the stack is supplemented by a lateral guide wall, which ensures the stack is in a position secured against slipping when it is being transported onwards to the site of the de-stacking operation.

9. The apparatus according to claim 5, wherein, when the stack is being taken up by the transporting device, the receiving support is in a pivoted position, in that the receiving support together with the stack is being transported via an angled guide to the site of the de-stacking operation, in that the angled guide has an inclination that corresponds to the position of the stack before the de-stacking operation is initiated.

10. The apparatus according to claim 9, wherein the gradient of the inclination of the printed products that are in the stack is aligned parallel to the gradient of the conveyor belt.

11. The apparatus according to claim 5, wherein the retaining means is driven by a mechanical, electrical, hydraulic force with action on the printed products that are above the printed product that is at the very bottom.

12. An apparatus for separating printed products that have been assembled into a stack, the apparatus comprising at least one transporting device and a de-stacking apparatus, in which is configured to separate the printed products in cycles, wherein the apparatus further comprises:
a) a transporting device, which is configured to take up a stack made available by a transporting belt, wherein the stack is being transported by the transporting device to the level of a de-stacking apparatus located underneath;
b) a receiving support which is part of the de-stacking apparatus is being moved up from an operating position vertically or virtually vertically towards the transporting device, until a position in which it is possible to transfer the stack from the de-stacking apparatus to the receiving support is reachable;
c) the receiving support with the taken-up stack moves back to its operating position, in which the de-stacking operation is initiated;
d) in the meantime, the transporting device moves back to its starting position to take up a subsequently supplied stack;
e) in this operating position, at least one force-applying element takes action and makes it possible to generate a vacuum force exerted on the printed product that is at the very bottom, wherein this force is intermittently deactivated as the printed product is conveyed onwards, to temporarily re-activate for the next printed product that is moved up;
f) underneath the force-applying element, the printed product that is at the very bottom is fed to a conveyor belt operable there, and the printed product is being transported onwards by means of a pusher dog chain which is operable in operative connection with the conveyor belt;
g) the rest of the printed products are successively released with intermittent deactivation of the force-applying element, and they then is being transported onwards individually in the same way.

13. The apparatus according to claim 12, wherein a light barrier or a sensor in the region of the transporting device detects the stack width and/or the width of the individual printed products and forwards this information to the de-stacking apparatus.

14. The apparatus according to claim 12, wherein the force-applying element is formed by a vacuum plate which is able to generate a vacuum force that makes it possible to exert a holding force on the printed product that has directly been taken in.

15. The apparatus according to claim 14, wherein the vacuum plate has a curved shape, which makes it possible to induce an optimized loosening behaviour and give the printed product higher stability.

16. The apparatus according to claim 14, wherein the vacuum plate is operatively connected to an adjustable retaining means.

17. The apparatus according to claim 16, wherein the end face of the retaining means is provided, at least on the same side as the printed products that are to be de-stacked are, with a chamfer, the bottom edge of which is settable lower down or higher up with respect to the thickness of the printed product that is lined up for de-stacking.

18. The apparatus according to claim 12, wherein the receiving support is provided with a vibrator in respect of the de-stacking operation.

19. The apparatus according to claim 12, wherein the receiving support is equipped with a reader for detecting the printed product thicknesses.

20. The apparatus according to claim 12, wherein the exerted vacuum force on the vacuum plate is operable by a feeding element in the receiving support.

21. The apparatus according to claim 12, wherein the end face of a retaining means which is part of the receiving support has, at least on the same side as the printed products that are to be de-stacked are, with a chamfer, the bottom edge of which is settable lower down or higher up with respect to the thickness of the printed product that is lined up for de-stacking, in such a way that these settings make it possible to implement the following operating states:
a) if the chamfer of the retaining means is positioned lower down than the printed product thickness i, the printed product that is to be de-stacked is conveyable onwards in impeded fashion owing to the reduced passage opening implemented;
b) if the chamfer of the retaining means is positioned higher up than the printed product thickness i, the printed product that is to be de-stacked is conveyable onwards freely;
c) in operating state b), to prevent a thin printed product that is lined up from slipping back and to take on the variable thicknesses of the printed products, the retaining means is provided with at least one throughflow opening, through which air is made to flow in to relieve the load on and/or release the stack.
